(19) United States
(12) Patent Application Publication
(10) Pub. No.: US 2025/0232739 A1
(43) Pub. Date: Jul. 17, 2025

(54) DISPLAY DEVICE

(71) Applicant: Japan Display Inc., Tokyo (JP)

(72) Inventors: Kazunari TOMIZAWA, Tokyo (JP); Akira HASEGAWA, Tokyo (JP)

(21) Appl. No.: 19/010,649

(22) Filed: Jan. 6, 2025

(30) Foreign Application Priority Data
Jan. 16, 2024 (JP) 2024-004414

(51) Int. Cl. G09G 3/36

(52) U.S. Cl. CPC G09G 3/3607; G09G 2320/0233; G09G 2320/0252; G09G 2320/0271; G09G 2320/0626; G09G 2320/0686

(57) ABSTRACT

According to an aspect, a display device includes: a display panel having a display area in which a plurality of pixels are arrayed in a first direction and a second direction orthogonal to the first direction; a light source configured to output light to the display panel; and a signal processing circuit configured to control the display panel and the light source, wherein the signal processing circuit sets a preset gradation value written to all pixels in the display area based on a frame image of one frame to be displayed in the display area, and the display panel has a preset period for writing the preset gradation value to all pixels in the display area before a write period for writing a gradation value for each pixel of the frame image in one frame period for displaying the frame image.

### CROSS-REFERENCE TO RELATED APPLICATION

This application claims the benefit of priority from Japanese Patent Application No. 2024-004414 filed on Jan. 16, 2024, the entire contents of which are incorporated herein by reference.

### BACKGROUND

### 1. Technical Field

The present invention relates to a display device.

### 2. Description of the Related Art

Display devices for virtual reality (VR) or augmented reality (AR), for example, are known in which a head-mounted display (HMD) is placed in front of the eyes of a user and the display of images changes with movement of the point of view. In such display devices, pixels are easily visually recognizable because a displayed video is magnified by lenses. Therefore, the definition of display panels is required to be higher.

As a method to make the definition of display panels higher, field-sequential color liquid crystal display devices are known that display color images by driving pixels by temporarily dividing one frame period into a plurality of sub-field periods and emitting light in colors different among the sub-field periods to a display area. The field-sequential method can express a plurality of colors with one pixel, and therefore, can achieve higher definition than the color filter method in which sub-pixels for a plurality of colors constitute one pixel.

On the other hand, VR systems using an HMD are required to achieve not only high definition but also a high frame rate to reduce delay and afterimage phenomena in a displayed image. To achieve a high frame rate in a liquid crystal display device, conventionally known is a method of writing signals of a predetermined gradation to all the pixels and then writing the gradation of video signals (e.g., Japanese Patent Application Laid-open Publication No. 2018-136495. This method can improve the response performance of liquid crystal and achieve a high frame rate.

In the related art described above, a certain gradation value is written to all the pixels in advance independently of the gradation values of the video signals. Therefore, the liquid crystal molecules may possibly fail to be driven in time for the lighting timing of a backlight depending on the gradation values of the video signals, resulting in deterioration of display quality.

For the foregoing reasons, there is a need for providing a display device that can suppress deterioration of display quality caused by collective presetting of pixel gradation values.

### SUMMARY

According to an aspect, a display device includes: a display panel having a display area in which a plurality of pixels are arrayed in a first direction and a second direction orthogonal to the first direction; a light source configured to output light to the display panel; and a signal processing circuit configured to control the display panel and the light source, wherein the signal processing circuit sets a preset gradation value written to all pixels in the display area based on a frame image of one frame to be displayed in the display area, and the display panel has a preset period for writing the preset gradation value to all pixels in the display area before a write period for writing a gradation value for each pixel of the frame image in one frame period for displaying the frame image.

### BRIEF DESCRIPTION OF THE DRAWINGS

FIG. 1 is a schematic diagram of an example of a block configuration of a display device according to an embodiment;

FIG. 2 is a schematic diagram of a configuration example of a display panel according to the embodiment;

FIG. 3 is a diagram of an example of one frame period according to a comparative example;

FIG. 4 is a diagram of an example of a response time taken to update a pixel gradation value;

FIG. 5A is a first diagram of an example of the operation according to the comparative example;

FIG. 5B is a second diagram of the example of the operation according to the comparative example;

FIG. 5C is a third diagram of the example of the operation according to the comparative example;

FIG. 5D is a fourth diagram of the example of the operation according to the comparative example;

FIG. 6 is a diagram of an example of one frame period according to the embodiment;

FIG. 7 is a block diagram of an example of a detailed configuration of the display device according to the embodiment;

FIG. 8 is a timing chart of a drive example of the display device according to the embodiment;

FIG. 9A is a first diagram of an example of the operation of the display device according to the embodiment;

FIG. 9B is a second diagram of the example of the operation of the display device according to the embodiment;

FIG. 9C is a third diagram of the example of the operation of the display device according to the embodiment;

FIG. 9D is a fourth diagram of the example of the operation of the display device according to the embodiment;

FIG. 10 is a schematic diagram of an example of a block configuration of the display device according to a modification of the embodiment;

FIG. 11 is a schematic diagram of a configuration example of the display panel according to the modification of the embodiment; and

FIG. 12 is a diagram of an example of one frame period according to the modification of the embodiment.

### DETAILED DESCRIPTION

The following describes modes (embodiments) for carrying out the present disclosure in detail with reference to the drawings. The present disclosure is not limited to the description of the embodiments to be given below. Components to be described below include those easily conceivable by those skilled in the art or those substantially identical thereto. In addition, the components to be described below can be combined as appropriate. What is disclosed herein is merely an example, and the present disclosure naturally encompasses appropriate modifications easily conceivable by those skilled in the art while maintaining the gist of the disclosure. To further clarify the description, the drawings are schematically illustrated, for example, widths, thicknesses, and shapes of various parts as compared with actual aspects thereof, in some cases. However, they are merely examples, and interpretation of the present disclosure is not limited thereto. The same element as that illustrated in a drawing that has already been discussed is denoted by the same reference numeral through the description and the drawings, and detailed description thereof may be appropriate omitted.

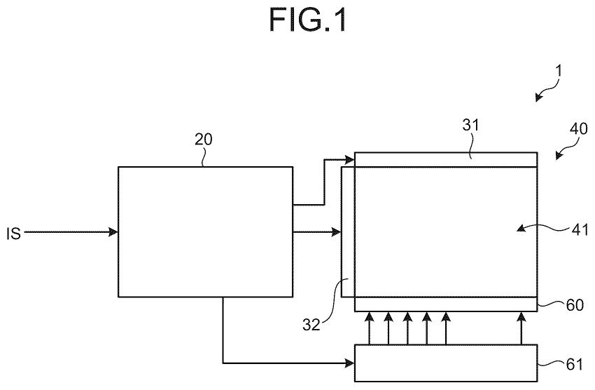

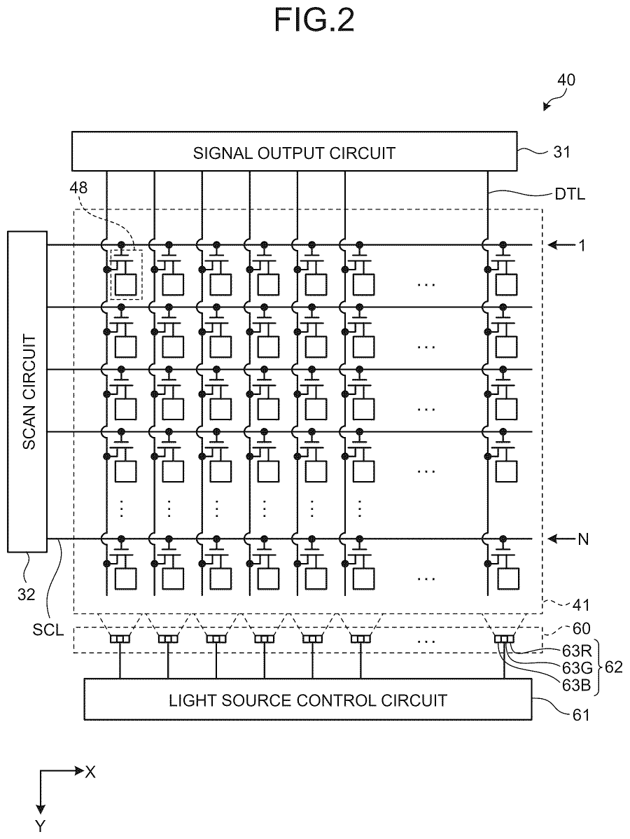

FIG. 1 is a schematic diagram of an example of a block configuration of a display device according to an embodiment. FIG. 2 is a schematic diagram of a configuration example of a display panel according to the embodiment. A display device 1 according to the embodiment includes a signal processing circuit 20, a display panel 40, and a light source 60 as a main block configuration. The display panel 40 includes a signal output circuit 31 and a scan circuit 32. The display panel 40 according to the present disclosure is, for example, an active matrix color liquid crystal display panel driven based on what is called a field-sequential color (FSC) method.

The display panel 40 is controlled to be driven based on signals from the signal processing circuit 20. The display panel 40 according to the present disclosure is a liquid crystal display panel in which polymer dispersed liquid crystal (PDLC) (hereinafter, also referred to simply as “liquid crystal”) is sealed between substrates disposed facing each other. The light source 60 illuminates the display panel 40 from the back side. The display panel 40 displays the images using the signals from the signal processing circuit 20 and light from the light source 60.

As illustrated in FIG. 2, the display panel 40 is provided with a display area 41 in which a plurality of pixels 48 are arranged in an X-direction (first direction) and a Y-direction (second direction). The Y-direction (second direction) is a direction that intersects the X-direction (first direction). More specifically, in the example illustrated in FIG. 1, the Y-direction (second direction) is a direction orthogonal to the X-direction (first direction).

The pixels 48 each include a switching element and a pixel electrode. The orientation of liquid crystal molecules contained in the liquid crystal layer of the display panel 40 is determined corresponding to the potential of the pixel electrode. Thus, the light transmittance of each pixel 48 is controlled.

The switching element is a switching element using, for example, a semiconductor, such as a thin-film transistor (TFT). One of the source and the drain of the switching element is coupled to a corresponding one of signal lines DTL. The other of the source and the drain of the switching element is coupled to the pixel electrode. The gate of the switching element is coupled to a corresponding one of scan lines SCL.

The signal processing circuit 20 outputs various signals for controlling operations of the signal output circuit 31, the scan circuit 32, and a light source control circuit 61 in response to input signals from the outside.

The signal output circuit 31 outputs a pixel signal SIG of a gradation value corresponding to a frame image IS supplied from the signal processing circuit 20 to each of pixels arrayed in the X-direction (first direction). In the present disclosure, the number of the signal lines DTL is M (where M is a natural number). In the following description, the m-th signal line DTL (m is a natural number from 1 to M) out of the signal lines DTL arrayed in the X-direction (first direction) is also referred to as “signal line DTL<m>”. The pixel signal SIG supplied from the signal output circuit 31 to the signal line DTL<m> is also referred to as “pixel signal SIG<m>”

The scan circuit 32 sequentially outputs drive signals GATE to the scan lines SCL arrayed in the Y-direction (second direction). The scan circuit 32 scans the display panel 40 by shifting the scan lines SCL that output the drive signals. In the present disclosure, the number of the scan lines SCL is N (where N is a natural number). In the following description, the n-th scan line SCL (n is a natural number from 1 to N) out of the scan lines SCL arrayed in the Y-direction (second direction) is also referred to as “scan line SCL<n>”. The drive signal GATE output from the scan circuit 32 to the scan line SCL<n> is also referred to as “drive signal GATE<n>”.

More specifically, the signal output circuit 31 supplies the pixel signal SIG<m> to each of the pixels 48 coupled to the scan line SCL<n> to which the drive signal GATE<n> is supplied from the scan circuit 32.

The output target to which the drive signal GATE<n> is output may be shifted from the scan line SCL<1> to the scan line SCL<N> or from the scan line SCL<N> to the scan line SCL<1>. In the present disclosure, an example will be described in which the output target of the drive signal GATE<n> is shifted from the scan line SCL<1> to the scan line SCL<N>.

The light source 60 includes a plurality of light emission units 62. The light source 60 is coupled to the light source control circuit 61. The light source 60 is called a side light source. Light emitted from a plurality of light emitters arranged at an end of a light guide plate is transmitted through the light guide plate and output from the light source 60. The light output from the light source 60 passes through the display panel 40.

Each of the light emission units 62 includes a first light emitter 63R that outputs light of a first color (e.g., red), a second light emitter 63G that outputs light of a second color (e.g., green), and a third light emitter 63B that outputs light of a third color (e.g., blue). The light emitters are light-emitting diodes (LEDs), for example, but are not limited thereto. The light emitters may be cold cathode fluorescent lamps (CCFLs), for example. The light emitters are each coupled to the light source control circuit 61. The light source control circuit 61 controls the light emission timing, the light emission duration, and the light emission intensity under the operational control of the signal processing circuit 20.

Specifically, the light source control circuit 61 controls each of the first light emitter 63R, the second light emitter 63G, and the third light emitter 63B to emit light in a time-division manner based on light source control signals from the signal processing circuit 20.

The signal processing circuit 20 sequentially receives the frame images IS to the number of those corresponding to a frame rate (fps) as input signals. The frame rate (fps) indicates the number of frame images IS displayed in the display area 41 in a predetermined time (e.g., one second).

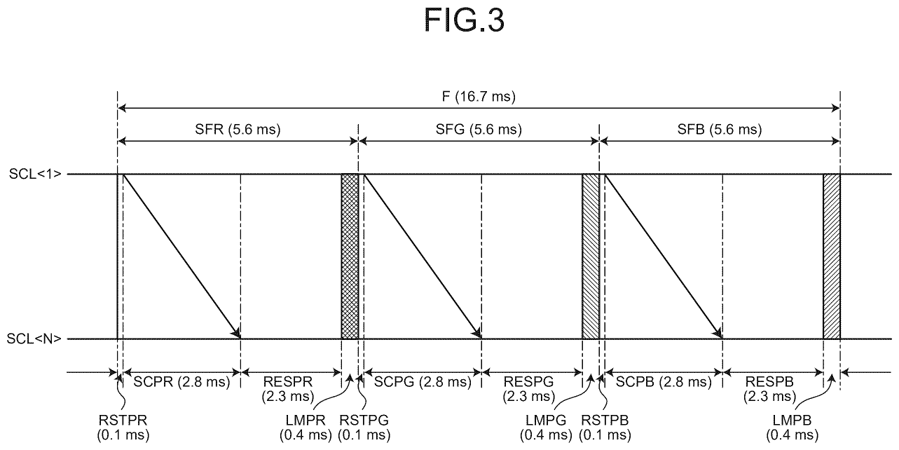

FIG. 3 is a diagram of an example of one frame period according to a comparative example. Hereafter, a period in which one frame image (one screen) is displayed in the display area is referred to as one frame period F. In the present disclosure, the one frame period F is 16.7 ms, for example. In other words, the frame rate according to the present disclosure is set to 60 Hz.

As illustrated in FIG. 3, in the comparative example, the one frame period F is equally divided into three periods of a first sub-field period SFR, a second sub-field period SFG, and a third sub-field period SFB.

The first sub-field period SFR has a write period SCPR for the first color. A response period RESPR is provided between the write period SCPR and a light emission period LMPR of the first light emitter 63R.

The second sub-field period SFG has a write period SCPG for the second color. A response period RESPG is provided between the write period SCPG and a light emission period LMPG of the second light emitter 63G.

The third sub-field period SFB has a write period SCPB for the third color. A response period RESPB is provided between the write period SCPB and a light emission period LMPB of the third light emitter 63B.

In the comparative example illustrated in FIG. 3, the first sub-field period SFR, the second sub-field period SFG, and the third sub-field period SFB are each set to 5.6 ms. The write periods SCPR, SCPG, and SCPB are each set to 2.8 ms. The response periods RESPR, RESPG, and RESPB are each set to 2.3 ms. The light emission periods LMPR, LMPG, and LMPB are each set to 0.4 ms.

In the following description, the pixel signal SIG<m> corresponding to the first color (e.g., red) of the frame image IS also referred to simply as “pixel signal SIGR<m>”. The pixel signal SIG<m> corresponding to the second color (e.g., green) of the frame image IS also referred to simply as “pixel signal SIGG<m>”. The pixel signal SIG<m> corresponding to the third color (e.g., blue) of the frame image IS also referred to simply as “pixel signal SIGB<m>”.

In the write period SCPR, the scan circuit 32 shifts the output target of the drive signal GATE<n> from the scan line SCL<1> to the scan line SCL<N>. The signal output circuit 31 supplies the pixel signal SIGR<m> corresponding to the first color of the frame image IS to each of the pixels 48 coupled to the scan line SCL<n> to which the drive signal GATE<n> is supplied from the scan circuit 32.

The light source control circuit 61 turns on the first light emitters 63R in the light emission period LMPR after the response period RESPR.

In the subsequent write period SCPG, the scan circuit 32 shifts the output target of the drive signal GATE<n> from the scan line SCL<1> to the scan line SCL<N>. The signal output circuit 31 supplies the pixel signal SIGG<m> corresponding to the second color of the frame image IS to each of the pixels 48 coupled to the scan line SCL<n> to which the drive signal GATE<n> is supplied from the scan circuit 32.

The light source control circuit 61 turns on the second light emitters 63G in the light emission period LMPG after the response period RESPG.

In the subsequent write period SCPB, the scan circuit 32 shifts the output target of the drive signal GATE<n> from the scan line SCL<1> to the scan line SCL<N>. The signal output circuit 31 supplies the pixel signal SIGB<m> corresponding to the third color of the frame image IS to each of the pixels 48 coupled to the scan line SCL<n> to which the drive signal GATE<n> is supplied from the scan circuit 32.

The light source control circuit 61 turns on the third light emitters 63B in the light emission period LMPB after the response period RESPB.

Thus, the frame image IS of one frame is visually recognized by a user.

In the comparative example illustrated in FIG. 3, reset periods RSTPR, RSTPG, and RSTPB are further provided just before the write periods SCPR, SCPG, and SCPB, respectively. The reset periods RSTPR, RSTPG, and RSTPB are periods for writing a certain gradation value to all the pixels 48 included in the display area 41. The following describes the gradation value written in the reset periods RSTPR, RSTPG, and RSTPB in the comparative example.

In the following explanation, the pixel signal SIG<m> is described as an 8-bit gradation value. When a gradation value GV is a highest value of “255”, the degree of light transmission through the pixel 48 is the largest. When the gradation value GV is a lowest value of “0”, the degree of light transmission through the pixel 48 is the smallest.

In the following description, the first sub-field period SFR, the second sub-field period SFG, and the third sub-field period SFB may be referred to simply as “sub-field period SF”. The write periods SCPR, SCPG, and SCPB may be referred to simply as “write period SCP”. The response periods RESPR, RESPG, and RESPB may be referred to simply as “response periods RESP”. The light emission periods LMPR, LMPG, and LMPB may be referred to simply as “light emission periods LMP”. The reset periods RSTPR, RSTPG, and RSTPB may be referred to simply as “reset period RSTP”.

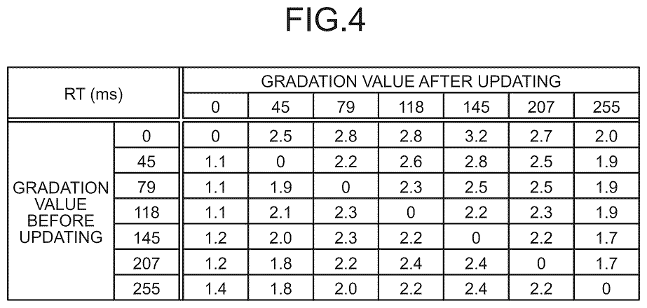

A response time associated with updating the gradation value differs depending on the gradation values before and after the updating. The response time is measured as a time from when the potential corresponding to the gradation value after updating is supplied to the pixel electrode to when the gradation value reaches 90% of the gradation value after updating. FIG. 4 is a diagram of an example of the response time taken to update the pixel gradation value.

In FIG. 4, while “0”, “45”, “79”, “118”, “145”, “207”, and “255” are illustrate by examples as the gradation values before and after updating, these are representative values, and the gradation values before and after updating are not limited thereto.

In a specific example focusing on the gradation value after updating, when the gradation value after updating is the lowest value of “0” and the gradation value before updating is “255”, the maximum value of a response time RT is 1.4 ms. When the gradation value after updating is the highest value of “255” and the gradation value before updating is “0”, the maximum value of the response time RT is 2.0 ms.

By contrast, when the gradation value after updating is “118” and the gradation value before updating is “0”, the maximum value of the response time RT is 2.8 ms. When the gradation value after updating is “145” and the gradation value before updating is “0”, the maximum value of the response time RT is 3.2 ms.

Thus, when the gradation value after updating is an intermediate gradation, the response time RT tends to be longer than when the gradation value after updating is the lowest value of “0” or the highest value of “255”.

Focusing on the gradation value before updating, when the gradation value before updating is “118”, the response time RT is within the response period RESP (2.3 ms) for all the gradation values after updating of “0”, “45”, “79”, “118”, “145”, “207” and “255”. When the gradation value after updating is “118”, the response time RT is within the write period SCP (2.8 ms) for all the gradation values before updating of “0”, “45”, “79”, “118”, “145”, “207” and “255”.

Therefore, the gradation value written in the reset period RSTP is assumed to be “118”.

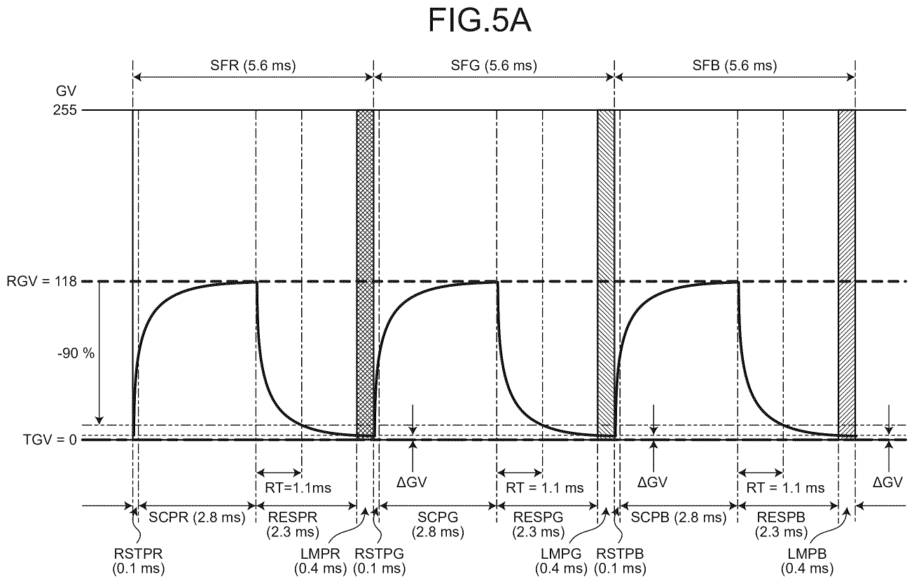

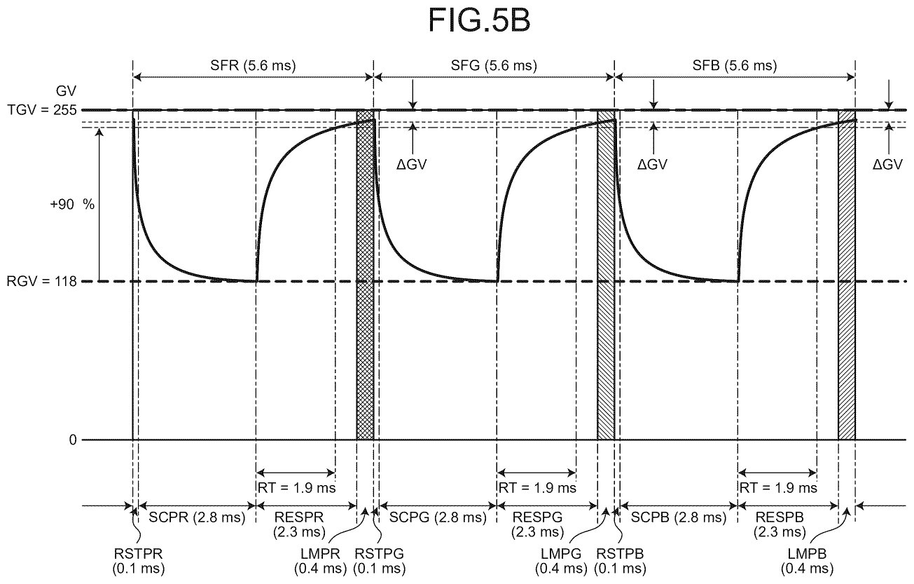

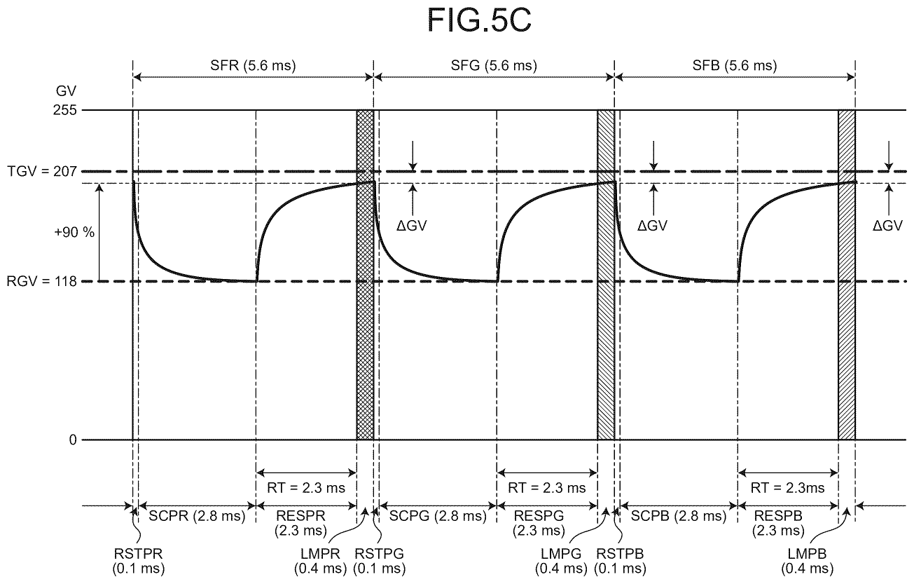

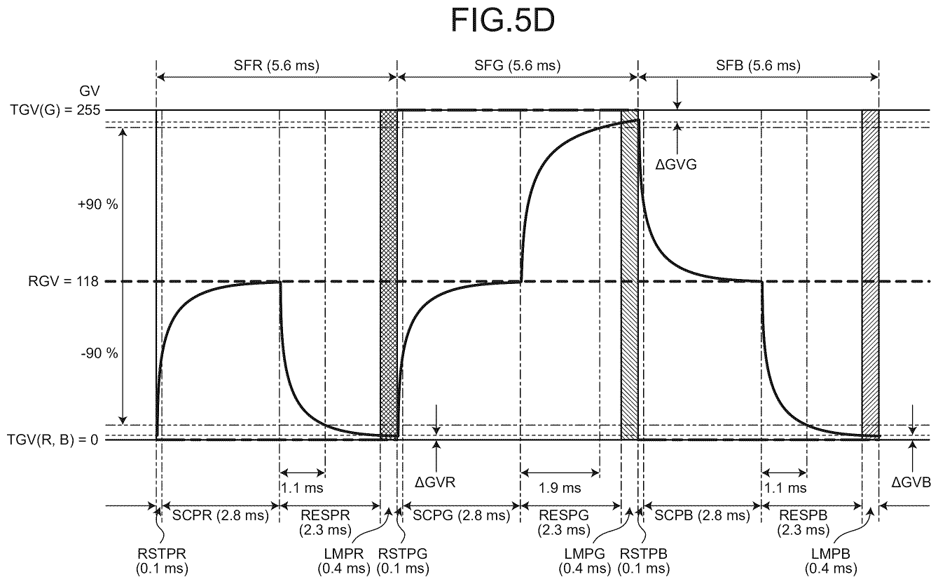

FIG. 5A is a first diagram of an example of the operation according to the comparative example. FIG. 5B is a second diagram of the example of the operation according to the comparative example. FIG. 5C is a third diagram of the example of the operation according to the comparative example. FIG. 5D is a fourth diagram of the example of the operation according to the comparative example.

FIGS. 5A, 5B, 5C, and 5D illustrate changes in the gradation value of the pixel 48 coupled to the scan line SCL<N>. In the examples illustrated in FIGS. 5A, 5B, 5C, and 5D, the gradation value written in the write period SCPR of the first sub-field period SFR is a target gradation value TGV(R). The gradation value written in the write period SCPG of the second sub-field period SFG is a target gradation value TGV(G). The gradation value written in the write period SCPB of the third sub-field period SFB is a target gradation value TGV(B). The target gradation values TGV(R), TGV(G), and TGV(B) are also referred to simply as “target gradation value TGV”.

In FIGS. 5A, 5B, 5C, and 5D, a reset gradation value RGV is set to a gradation value of “118” written to all the pixels 48 included in the display area 41 in the reset periods RSTPR, RSTPG, and RSTPB provided in the first sub-field period SFR, the second sub-field period SFG, and the third sub-field period SFB, respectively.

In FIGS. 5A, 5B, 5C, and 5D, to simplify the explanation, the reset gradation value RGV set in the reset period RSTP is assumed to reach 100% within the write period SCP (2.8 ms).

FIG. 5A illustrates an example where each of the gradation values of the pixel signal SIGR<m>, the pixel signal SIGG<m>, and the pixel signal SIGB<m> is the lowest value of “0”, that is, the frame image IS is an all-black image with a luminance of 0%.

In the example illustrated in FIG. 5A, when the target gradation value TGV=“0” is written as the gradation value of the pixel 48 coupled to the scan line SCL<N>, the luminance reaches a luminance obtained by subtracting 90% of the luminance difference between the luminance corresponding to the reset gradation value RGV=“118” and the luminance corresponding to the target gradation value TGV=“0” from the luminance corresponding to the reset gradation value RGV=“118”, in 1.1 ms after the start of the response period RESP. FIG. 5A illustrates an example where the light emission unit 62 is turned on in the light emission period LMP before reaching the luminance corresponding to the target gradation value TGV=“0”. As a result, the luminance may be higher than the luminance corresponding to the target gradation value TGV=“0” by a difference ΔGV in the lower part of the display area 41.

FIG. 5B illustrates an example where each of the gradation values of the pixel signal SIGR<m>, the pixel signal SIGG<m>, and the pixel signal SIGB<m> is the highest value of “255”, that is, the frame image IS is an all-white image with a luminance of 100%.

In the example illustrated in FIG. 5B, when the target gradation value TGV=“255” is written as the gradation value of the pixel 48 coupled to the scan line SCL<N>, the luminance reaches a luminance obtained by adding 90% of the luminance difference between the luminance corresponding to the target gradation value TGV=“255” and the luminance corresponding to the reset gradation value RGV=“118” to the luminance corresponding to the reset gradation value RGV=“118”, in 1.9 ms after the start of the response period RESP. FIG. 5B illustrates an example where the light emission unit 62 is turned on in the light emission period LMP before reaching the luminance corresponding to the target gradation value TGV=“255”. As a result, the luminance may be lower than the luminance corresponding to the target gradation value TGV=“255” by the difference ΔGV in the lower part of the display area 41.

FIG. 5C illustrates an example where the gradation values of the pixel signal SIGR<m>, the pixel signal SIGG<m>, and the pixel signal SIGB<m> are “207”.

In the example illustrated in FIG. 5C, when the target gradation value TGV=“207” is written as the gradation value of the pixel 48 coupled to the scan line SCL<N>, the luminance reaches a luminance obtained by adding 90% of the luminance difference between the luminance corresponding to the target gradation value TGV=“207” and the luminance corresponding to the reset gradation value RGV=“118” to the luminance corresponding to the reset gradation value RGV=“118”, in 2.3 ms after the start of the response period RESP. FIG. 5C illustrates an example where the light emission unit 62 is turned on in the light emission period LMP before reaching the luminance corresponding to the target gradation value TGV=“207”. As a result, the luminance may be lower than the luminance corresponding to the target gradation value TGV=“207” by the difference ΔGV in the lower part of the display area 41.

FIG. 5D illustrates an example where the gradation value of the pixel signal SIGR<m> is the lowest value of “0”, the gradation value of the pixel signal SIGG<m> is the highest value of “255”, and the gradation value of the pixel signal SIGB<m> is the lowest value of “0”, that is, the frame image IS is an all-green image.

In the example illustrated in FIG. 5D, when the target gradation value TGV(R)=“0” of the first color (herein, red) is written as the gradation value of the pixel 48 coupled to the scan line SCL<N>, the luminance reaches a luminance obtained by subtracting 90% of the luminance difference between the luminance corresponding to the reset gradation value RGV=“118” and the luminance corresponding to the target gradation value TGV(R)=“0” from the luminance corresponding to the reset gradation value RGV=“118”, in 1.1 ms after the start of the response period RESPR. FIG. 5D illustrates an example where the first light emitter 63R is turned on in the light emission period LMPR before reaching the luminance corresponding to the target gradation value TGV(R)=“0”. As a result, the luminance of red may be higher than the luminance corresponding to the target gradation value TGV(R)=“0” by a difference ΔGVR in the lower part of the display area 41.

In the example illustrated in FIG. 5D, when the target gradation value TGV(G)=“255” of the second color (herein, green) is written as the gradation value of the pixel 48 coupled to the scan line SCL<N>, the luminance reaches a luminance obtained by adding 90% of the luminance difference between the luminance corresponding to the target gradation value TGV(G)=“255” and the luminance corresponding to the reset gradation value RGV=“118” to the luminance corresponding to the reset gradation value RGV=“118”, in 1.9 ms after the start of the response period RESPG. FIG. 5D illustrates an example where the second light emitter 63G is turned on in the light emission period LMPG before reaching the luminance corresponding to the target gradation value TGV(G)=“255”. As a result, the luminance of green may be lower than the luminance corresponding to the target gradation value TGV(G)=“255” by a difference ΔGVG in the lower part of the display area 41.

In the example illustrated in FIG. 5D, when the target gradation value TGV(B)=“0” of the third color (herein, blue) is written as the gradation value of the pixel 48 coupled to the scan line SCL<N>, the luminance reaches a luminance obtained by subtracting 90% of the luminance difference between the luminance corresponding to the reset gradation value RGV=“118” and the luminance corresponding to the target gradation value TGV(B)=“0” from the luminance corresponding to the reset gradation value RGV=“118”, in 1.1 ms after the start of the response period RESPB. FIG. 5D illustrates an example where the third light emitter 63B is turned on in the light emission period LMPB before reaching the luminance corresponding to the target gradation value TGV(B)=“0”. As a result, the luminance of blue may be higher than the luminance corresponding to the target gradation value TGV(B)=“0” by a difference ΔGVB in the lower part of the display area 41. In the example illustrated in FIG. 5D, not only does the luminance of green fail to reach the luminance corresponding to an original gradation value of “255” of the pixel signal SIGG<m>, but the frame image IS visually recognized by the user is displayed by a mixed color of red and blue with green.

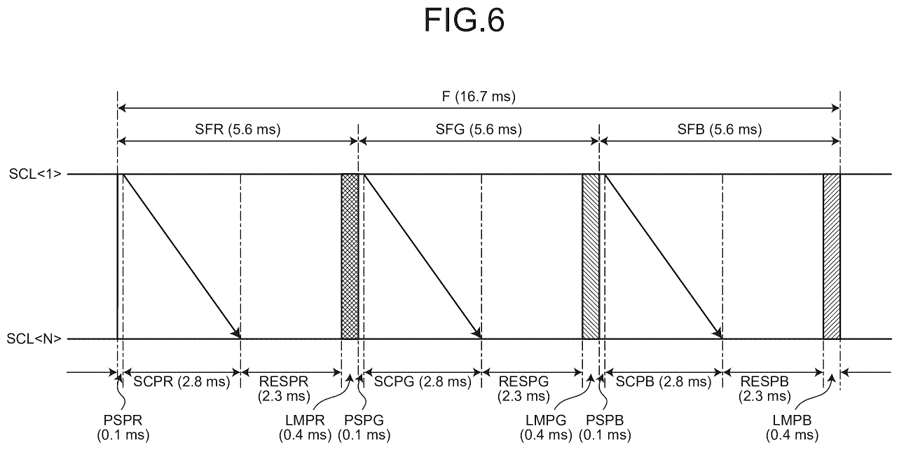

FIG. 6 is a diagram of an example of one frame period according to the embodiment. As illustrated in FIG. 6, the embodiment has preset periods PSPR, PSPG, and PSPB for writing preset gradation values PSGV(R), PSGV(G), and PSGV(B) set in advance according to the frame image IS supplied from the signal processing circuit 20 instead of the reset periods RSTPR, RSTPG, and RSTPB provided just before the write periods SCPR, SCPG, and SCPB according to the comparative example. The following describes the configuration and operation that can set the preset gradation values PSGV(R), PSGV(G), and PSGV(B) written to all the pixels 48 included in the display area 41 in the preset periods PSPR, PSPG, and PSPB provided in the first sub-field period SFR, the second sub-field period SFG, and the third sub-field period SFB, and the method of setting the preset gradation values PSGV(R), PSGV(G), and PSGV(B).

In the following description, the pixel signal SIGR<m> corresponding to the pixel 48 in the m-th column and the n-th row is referred to as “pixel signal SIGR<m,n>”. The pixel signal SIGG<m> corresponding to the pixel 48 in the m-th column and the n-th row is referred to as “pixel signal SIGG<m,n>”. The pixel signal SIGB<m> corresponding to the pixel 48 in the m-th column and the n-th row is referred to as “pixel signal SIGB<m,n>”.

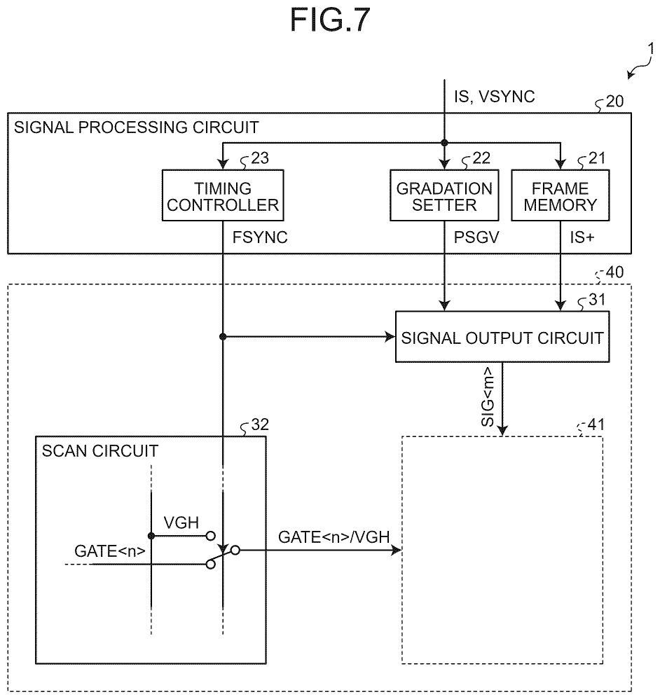

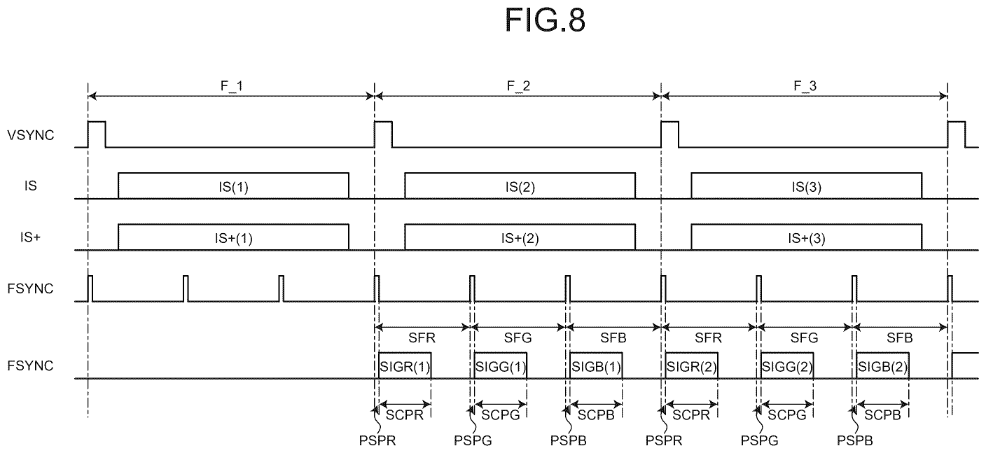

FIG. 7 is a block diagram of an example of a detailed configuration of the display device according to the embodiment. FIG. 8 is a timing chart of a drive example of the display device according to the embodiment.

As illustrated in FIG. 7, the signal processing circuit 20 according to the present disclosure includes a frame memory 21, a gradation setter 22, and a timing controller 23.

As illustrated in FIG. 8, the signal processing circuit 20 according to the present disclosure receives the frame image IS and a first synchronization signal VSYNC as input signals. The first synchronization signal VSYNC is a signal that defines one frame period F for displaying the frame image IS of one frame.

In a frame period F_1, the signal processing circuit 20 acquires a frame image IS(1) of one frame and stores it in the frame memory 21 as a frame image IS+(1).

The gradation setter 22 sets the preset gradation values PSGV(R), PSGV(G), and PSGV(B) based on the frame image IS(1) of one frame acquired in the frame period F_1. The gradation setter 22 according to the present disclosure sets an average value SIGRave of all the pixel signals SIGR<m,n> corresponding to the first color (herein, red) of the frame image IS of one frame as the preset gradation value PSGV(R). The preset gradation value PSGV(R) is expressed by the following Expression (1).

$$PSGV ( R ) = SIGRave = \frac{{\sum }_{m = 0}^{M} {\sum }_{n = 0}^{N} SIGR 〈 m , n 〉}{m \times n} \qquad ( 1 )$$

The gradation setter 22 according to the present disclosure sets an average value SIGGave of all the pixel signals SIGG<m,n> corresponding to the second color (herein, green) of the frame image IS of one frame as the preset gradation value PSGV(G). The preset gradation value PSGV(G) is expressed by the following Expression (2).

$$PSGV ( G ) = SIGGave = \frac{{\sum }_{m = 0}^{M} {\sum }_{n = 0}^{N} SIGG 〈 m , n 〉}{m \times n} \qquad ( 2 )$$

The gradation setter 22 according to the present disclosure sets an average value SIGBave of all the pixel signals SIGB<m,n> corresponding to the third color (herein, blue) of the frame image IS of one frame as the preset gradation value PSGV(B). The preset gradation value PSGV(B) is expressed by the following Expression (3).

$$PSGV ( B ) = SIGBave = \frac{{\sum }_{m = 0}^{M} {\sum }_{n = 0}^{N} SIGB 〈 m , n 〉}{m \times n} \qquad ( 3 )$$

While Expressions (1), (2), and (3) above indicate an example where the average value of the gradation values of each color for the respective pixels 48 of the frame image IS is set as the preset gradation values PSGV(R), PSGV(G), and PSGV(B) of each color, the preset gradation values PSGV(R), PSGV(G), and PSGV(B) are not limited to the average value of the gradation values of each color for the respective pixels 48 of the frame image IS.

The timing controller 23 generates a second synchronization signal FSYNC that defines one sub-field period SF based on the first synchronization signal VSYNC and outputs it to the display panel 40.

In the preset period PSPR of the first sub-field period SFR of the next frame period F_2, the scan circuit 32 applies a gate-on potential VGH to all the scan lines SCL in the display area 41. Specifically, the scan circuit 32 applies the gate-on potential VGH to all the scan lines SCL in the display area 41 in synchronization with the second synchronization signal FSYNC. The signal output circuit 31 supplies the preset gradation value PSGV(R) to all the signal lines DTL in the display area 41. As a result, the potential corresponding to the preset gradation value PSGV(R) is supplied to the pixel electrodes of all the pixels 48 in the display area 41.

In the subsequent write period SCPR, the scan circuit 32 sequentially outputs the drive signal GATE<n> to the scan lines SCL arrayed in the Y-direction (second direction). The signal output circuit 31 supplies a pixel signal SIGR(1)<m> to each of the pixels 48 coupled to the scan line SCL<n> to which the drive signal GATE<n> is supplied from the scan circuit 32. Thus, the pixel signal SIGR(1)<m> of the frame image IS+(1) stored in the frame memory 21 is sequentially written.

In the preset period PSPG of the subsequent second sub-field period SFG, the scan circuit 32 applies the gate-on potential VGH to all the scan lines SCL in the display area 41. Specifically, the scan circuit 32 applies the gate-on potential VGH to all the scan lines SCL in the display area 41 in synchronization with the second synchronization signal FSYNC. The signal output circuit 31 supplies the preset gradation value PSGV(G) to all the signal lines DTL in the display area 41. As a result, the potential corresponding to the preset gradation value PSGV(G) is supplied to the pixel electrodes of all the pixels 48 in the display area 41.

In the subsequent write period SCPG, the scan circuit 32 sequentially outputs the drive signal GATE<n> to the scan lines SCL arrayed in the Y-direction (second direction). The signal output circuit 31 supplies a pixel signal SIGG(1)<m> to each of the pixels 48 coupled to the scan line SCL<n> to which the drive signal GATE<n> is supplied from the scan circuit 32. Thus, the pixel signals SIGG(1)<m> of the frame image IS+(1) stored in the frame memory 21 is sequentially written.

In the preset period PSPB of the subsequent third sub-field period SFB, the scan circuit 32 applies the gate-on potential VGH to all the scan lines SCL in the display area 41. Specifically, the scan circuit 32 applies the gate-on potential VGH to all the scan lines SCL in the display area 41 in synchronization with the second synchronization signal FSYNC. The signal output circuit 31 supplies the preset gradation value PSGV(B) to all the signal lines DTL in the display area 41. As a result, the potential corresponding to the preset gradation value PSGV(B) is supplied to the pixel electrodes of all the pixels 48 in the display area 41.

In the subsequent write period SCPB, the scan circuit 32 sequentially outputs the drive signal GATE<n> to the scan lines SCL arrayed in the Y-direction (second direction). The signal output circuit 31 supplies a pixel signal SIGB(1)<m> to each of the pixels 48 coupled to the scan line SCL<n> to which the drive signal GATE<n> is supplied from the scan circuit 32. Thus, the pixel signals SIGB(1)<m> of the frame image IS+(1) stored in the frame memory 21 is sequentially written.

In the frame period F_2, the signal processing circuit 20 acquires a frame image IS(2) of one frame and stores it in the frame memory 21 as a frame image IS+(2).

The gradation setter 22 sets the preset gradation values PSGV(R), PSGV(G), and PSGV(B) based on the frame image IS(2) of one frame acquired in the frame period F_2.

In the preset period PSPR of the first sub-field period SFR of the next frame period F_3, the scan circuit 32 applies a gate-on potential VGH to all the scan lines SCL in the display area 41. Specifically, the scan circuit 32 applies the gate-on potential VGH to all the scan lines SCL in the display area 41 in synchronization with the second synchronization signal FSYNC. The signal output circuit 31 supplies the preset gradation value PSGV(R) to all the signal lines DTL in the display area 41. As a result, the potential corresponding to the preset gradation value PSGV(R) is supplied to the pixel electrodes of all the pixels 48 in the display area 41.

In the subsequent write period SCPR, the scan circuit 32 sequentially outputs the drive signal GATE<n> to the scan lines SCL arrayed in the Y-direction (second direction). The signal output circuit 31 supplies a pixel signal SIGR(2)<m> to each of the pixels 48 coupled to the scan line SCL<n> to which the drive signal GATE<n> is supplied from the scan circuit 32. Thus, the pixel signals SIGR(2)<m> of the frame image IS+(2) stored in the frame memory 21 is sequentially written.

In the preset period PSPG of the subsequent second sub-field period SFG, the scan circuit 32 applies the gate-on potential VGH to all the scan lines SCL in the display area 41. Specifically, the scan circuit 32 applies the gate-on potential VGH to all the scan lines SCL in the display area 41 in synchronization with the second synchronization signal FSYNC. The signal output circuit 31 supplies the preset gradation value PSGV(G) to all the signal lines DTL in the display area 41. As a result, the potential corresponding to the preset gradation value PSGV(G) is supplied to the pixel electrodes of all the pixels 48 in the display area 41.

In the subsequent write period SCPG, the scan circuit 32 sequentially outputs the drive signal GATE<n> to the scan lines SCL arrayed in the Y-direction (second direction). The signal output circuit 31 supplies a pixel signal SIGG(2)<m> to each of the pixels 48 coupled to the scan line SCL<n> to which the drive signal GATE<n> is supplied from the scan circuit 32. Thus, the pixel signals SIGG(2)<m> of the frame image IS+(2) stored in the frame memory 21 is sequentially written.

In the preset period PSPB of the subsequent third sub-field period SFB, the scan circuit 32 applies the gate-on potential VGH to all the scan lines SCL in the display area 41. Specifically, the scan circuit 32 applies the gate-on potential VGH to all the scan lines SCL in the display area 41 in synchronization with the second synchronization signal FSYNC. The signal output circuit 31 supplies the preset gradation value PSGV(B) to all the signal lines DTL in the display area 41. As a result, the potential corresponding to the preset gradation value PSGV(B) is supplied to the pixel electrodes of all the pixels 48 in the display area 41.

In the subsequent write period SCPB, the scan circuit 32 sequentially outputs the drive signal GATE<n> to the scan lines SCL arrayed in the Y-direction (second direction). The signal output circuit 31 supplies a pixel signal SIGB(2)<m> to each of the pixels 48 coupled to the scan line SCL<n> to which the drive signal GATE<n> is supplied from the scan circuit 32. Thus, the pixel signals SIGB(2)<m> of the frame image IS+(2) stored in the frame memory 21 is sequentially written.

By repeating the same operation thereafter, the frame image IS displayed in the display area 41 is updated every frame period F.

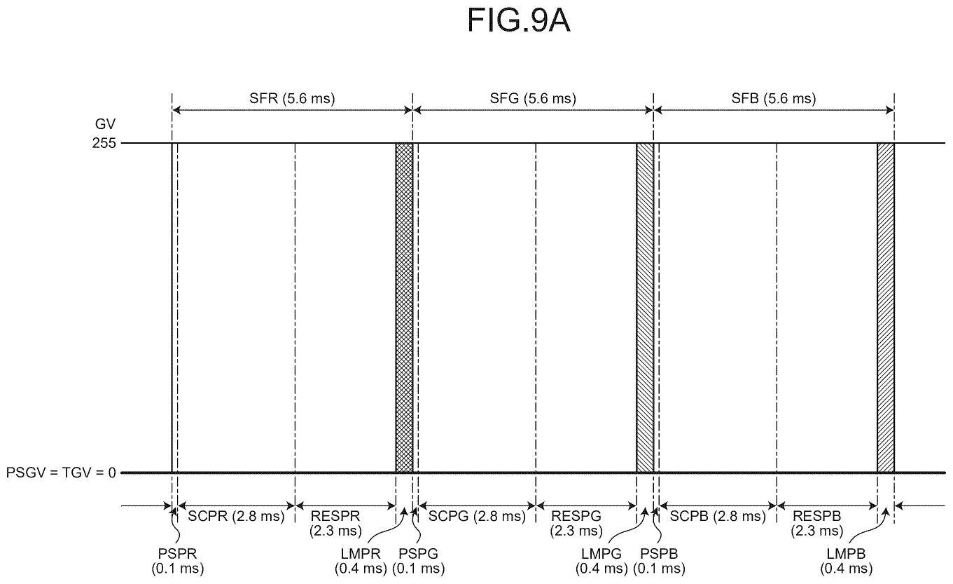

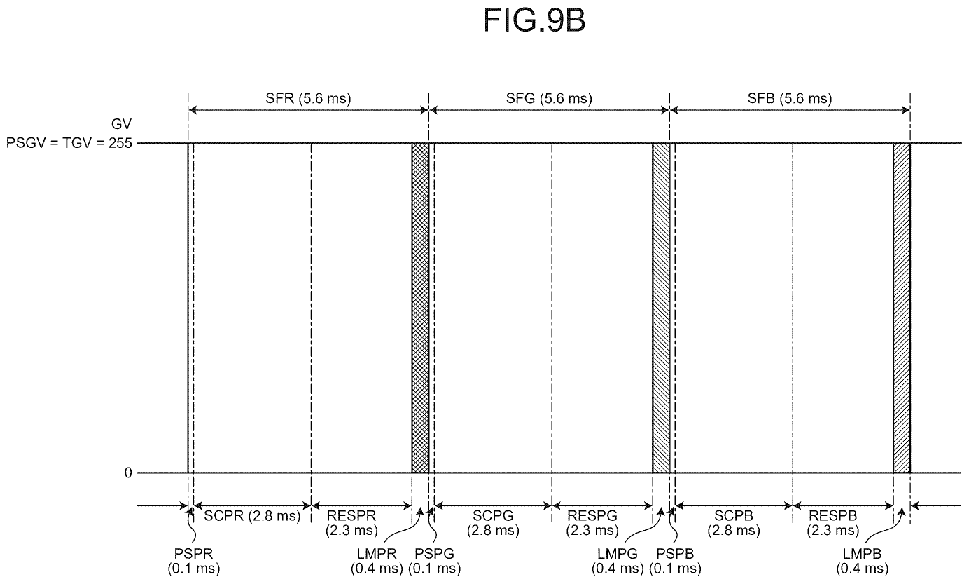

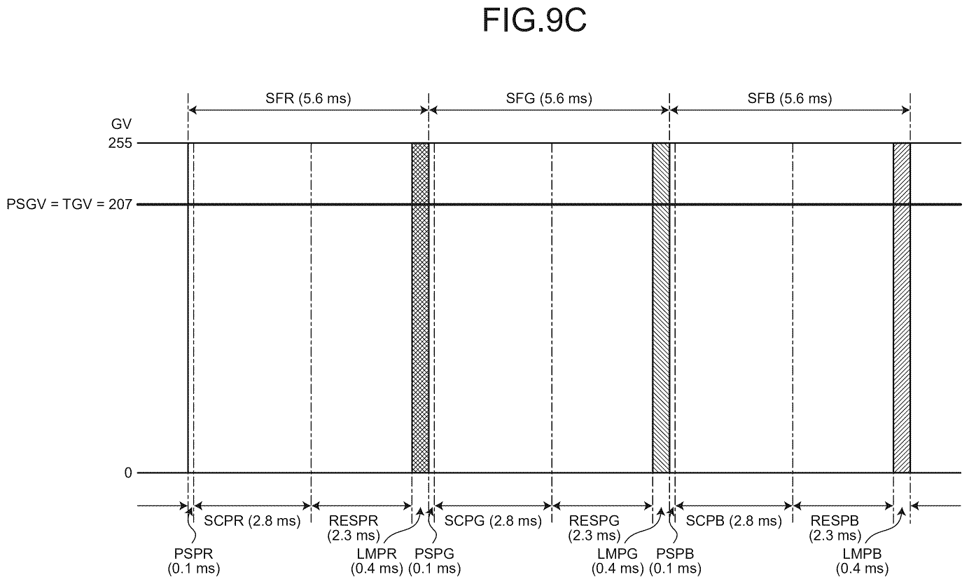

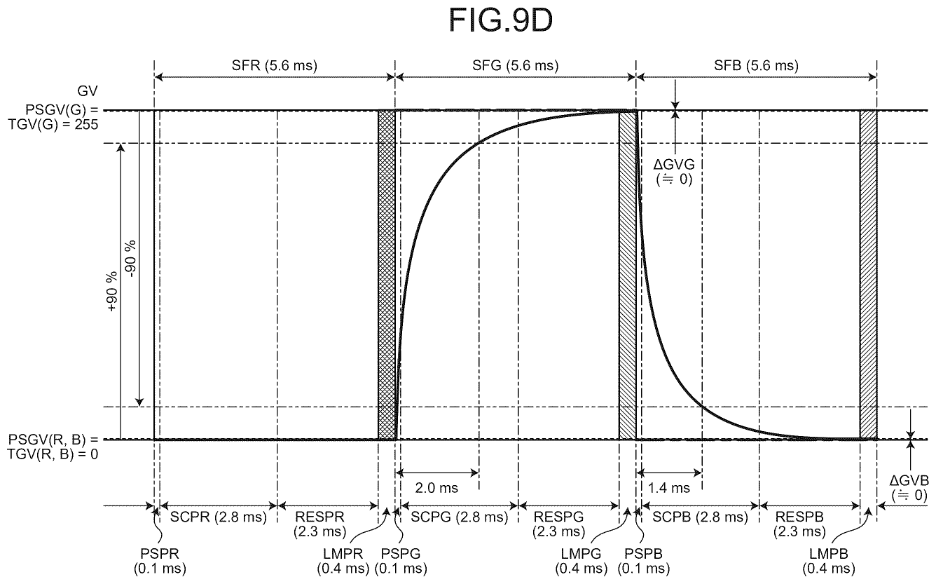

FIG. 9A is a first diagram of an example of the operation of the display device according to the embodiment. FIG. 9B is a second diagram of the example of the operation of the display device according to the embodiment. FIG. 9C is a third diagram of the example of the operation of the display device according to the embodiment. FIG. 9D is a fourth diagram of the example of the operation of the display device according to the embodiment.

FIGS. 9A, 9B, 9C, and 9D illustrate changes in the gradation value of the pixel 48 coupled to the scan line SCL<N> as in FIGS. 5A, 5B, 5C, and 5D. In the examples illustrated in FIGS. 9A, 9B, 9C, and 9D, the gradation value written in the write period SCPR of the first sub-field period SFR is the target gradation value TGV(R) as in FIGS. 5A, 5B, 5C, and 5D. The gradation value written in the write period SCPG of the second sub-field period SFG is the target gradation value TGV(G). The gradation value written in the write period SCPB of the third sub-field period SFB is the target gradation value TGV(B). The target gradation values TGV(R), TGV(G), and TGV(B) are also referred to simply as “target gradation value TGV” as in FIGS. 5A, 5B, 5C, and 5D.

FIGS. 9A, 9B, 9C, and 9D illustrate the changes in the gradation value when the average value of the gradation values of each color for the respective pixels 48 of the frame image IS is set as the preset gradation values PSGV(R), PSGV(G), and PSGV(B) of each color.

In the example of the operation of the display device 1 according to the embodiment, the preset gradation value PSGV(R) set by the gradation setter 22 is written in the preset period PSPR provided in the first sub-field period SFR. The preset gradation value PSGV(G) set by the gradation setter 22 is written in the preset period PSPG provided in the second sub-field period SFG. The preset gradation value PSGV(B) set by the gradation setter 22 is written in the preset period PSPB provided in the third sub-field period SFB. The preset gradation values PSGV(R), PSGV(G), and PSGV(B) are also referred to simply as “preset gradation value PSGV”.

As in FIG. 5A, FIG. 9A illustrates an example where each of the gradation values of the pixel signal SIGR<m>, the pixel signal SIGG<m>, and the pixel signal SIGB<m> is the lowest value of “0”, that is, the frame image IS is an all-black image with a luminance of 0%. In this example, each of the target gradation values TGV(R), TGV(G), and TGV(B) of the pixel 48 coupled to the scan line SCL<N> is the common target gradation value TGV=“0” for all the pixels 48.

In the example illustrated in FIG. 9A, the preset gradation value PSGV written in the preset periods PSPR, PSPG, and PSPB, respectively is “0”, which is equal to the target gradation value TGV. Therefore, the difference ΔGV with respect to the luminance corresponding to the target gradation value TGV=“0” is not theoretically generated in the light emission periods LMPR, LMPG, and LMPB after the response periods RESPR, RESPG, and RESPB have elapsed.

In particular, when the frame image IS is an all-black image with a luminance of 0%, a slightly higher luminance is more likely to be visually recognized, which makes the impression that the sharpness of black is impaired. In this case, the contrast ratio of the display panel deteriorates.

For this reason, it is preferred that the preset gradation values PSGV(R), PSGV(G), and PSGV(B) set based on the frame image IS are values such that the luminance of the frame image IS visually recognized by the user is the luminance corresponding to the target gradation value TGV=“0” when the frame image IS is an all-black image with a luminance of 0%. Specifically, for example, the average value of the gradation values of each color for the respective pixels 48 of the frame image IS can be set as the preset gradation values PSGV(R), PSGV(G), and PSGV(B) of each color as described above.

As in FIG. 5B, FIG. 9B illustrates an example where each of the gradation values of the pixel signal SIGR<m>, the pixel signal SIGG<m>, and the pixel signal SIGB<m> is the highest value of “255”, that is, the frame image IS is an all-white image with a luminance of 100%. In this example, each of the target gradation values TGV(R), TGV(G), and TGV(B) of the pixel 48 coupled to the scan line SCL<N> is the common target gradation value TGV=“255” for all the pixels 48.

In the example illustrated in FIG. 9B, the preset gradation value PSGV written in the preset periods PSPR, PSPG, and PSPB, respectively is “255,” which is equal to the target gradation value TGV. Therefore, the difference ΔGV with respect to the luminance corresponding to the target gradation value TGV=“255” is not theoretically generated in the light emission periods LMPR, LMPG, and LMPB after the response periods RESPR, RESPG, and RESPB have elapsed.

In particular, when the frame image IS is an all-white image with a luminance of 100%, reduction in luminance makes the impression that the contrast is reduced. In this case, the contrast ratio of the display panel deteriorates. For this reason, the preset gradation values PSGV(R), PSGV(G), and PSGV(B) set based on the frame image IS are preferably such values that the luminance of the frame image IS visually recognized by the user is the luminance corresponding to the target gradation value TGV=“255” when the frame image IS is an all-white image with a luminance of 100%. Specifically, for example, the average value of the gradation values of each color for the respective pixels 48 of the frame image IS can be set as the preset gradation values PSGV(R), PSGV(G), and PSGV(B) of each color as described above.

As in FIG. 5C, FIG. 9C illustrates an example where the gradation values of the pixel signal SIGR<m>, the pixel signal SIGG<m>, and the pixel signal SIGB<m> are the highest gradation value of “207”. In this example, the target gradation values TGV(R), TGV(G), and TGV(B) of the pixel 48 coupled to the scan line SCL<N> are the common target gradation value TGV=“207” for all the pixels 48.

In the example illustrated in FIG. 9C, the preset gradation value PSGV written in the preset periods PSPR, PSPG, and PSPB, respectively is “207”, which is equal to the target gradation value TGV. Therefore, the difference ΔGV with respect to the luminance corresponding to the target gradation value TGV=“207” is not theoretically generated in the light emission periods LMPR, LMPG, and LMPB after the response periods RESPR, RESPG, and RESPB have elapsed.

As in FIG. 5D, FIG. 9D illustrates an example where the gradation value of the pixel signal SIGR<m> is the lowest value of “0”, the gradation value of the pixel signal SIGG<m> is the highest value of “255”, and the gradation value of the pixel signal SIGB<m> is the lowest value of “0”, that is, the frame image IS is an all-green image. In this example, the target gradation value TGV(R) of the pixel 48 coupled to the scan line SCL<N> is the common target gradation value TGV(R)=“0” for all the pixels 48. The target gradation value TGV(G) of the pixel 48 coupled to the scan line SCL<N> is the common target gradation value TGV(G)=“255” for all the pixels 48. The target gradation value TGV(B) of the pixel 48 coupled to the scan line SCL<N> is the common target gradation value TGV(B)=“0” for all the pixels 48.

In the example illustrated in FIG. 9D, the preset gradation value PSGV(R) written in the preset period PSPR is “0”, which is equal to the target gradation value TGV(R). Therefore, the difference ΔGVR with respect to the luminance corresponding to the target gradation value TGV(R)=“0” is not theoretically generated in the light emission period LMPR after the response period RESPR has elapsed.

In the example illustrated in FIG. 9D, the preset gradation value PSGV(G) written in the preset period PSPG is “255”, which is equal to the target gradation value TGV(G). When the preset gradation value PSGV(R)=“255” is written in the preset period PSPG, the luminance reaches a luminance obtained by adding 90% of the luminance difference between the luminance corresponding to the preset gradation value PSGV(G)=“255” and the luminance corresponding to the target gradation value TGV(R)=“0” to the luminance corresponding to the target gradation value TGV(R)=“0”, in 2.0 ms after the start of the preset period PSPG. FIG. 9D illustrates an example where the luminance substantially reaches the luminance corresponding to the target gradation value TGV(G)=“255” after the response period RESPG has elapsed, and the second light emitter 63G is turned on in the light emission period LMPG. As a result, the difference ΔGVG with respect to the luminance corresponding to the target gradation value TGV(G)=“255” can be made approximately zero (ΔGVG≈0) in the lower part of the display area 41.

In the example illustrated in FIG. 9D, the preset gradation value PSGV(B) written in the preset period PSPB is “0”, which is equal to the target gradation value TGV(B). When the preset gradation value PSGV(B)=“255” is written in the preset period PSPB, the luminance reaches a luminance obtained by subtracting 90% of the luminance difference between the luminance corresponding to the target gradation value TGV(G)=“255” and the luminance corresponding to the preset gradation value PSGV(B)=“0” from the luminance corresponding to the target gradation value TGV(G)=“255”, in 1.4 ms after the start of the preset period PSPB. FIG. 9D illustrates an example where the luminance substantially reaches the luminance corresponding to the target gradation value TGV(B)=“0” after the response period RESPB has elapsed, and the third light emitter 63B is turned on in the light emission period LMPB. As a result, the difference ΔGVB with respect to the luminance corresponding to the target gradation value TGV(B)=“0” can be made approximately zero (ΔGVB≈0) in the lower part of the display area 41.

In the example illustrated in FIG. 9D, the preset period PSPR for writing the preset gradation values PSGV(R), PSGV(G), and PSGV(B) to all the pixels 48 in the display area 41 is provided just before the write periods SCPR, SCPG, and SCPB. By writing the preset gradation values PSGV(R), PSGV(G), and PSGV(B) (e.g., the average value of the gradation values of each color for the respective pixels 48 of the frame image IS) set in advance according to the frame image IS, the luminance of green reaches the luminance corresponding to an original gradation value of “255” of the pixel signal SIGG<m>. The frame image IS visually recognized by the user can be prevented from being displayed by a mixed color of red and blue with green.

In the configuration according to the embodiment described above, the preset gradation value PSGV written to all the pixels 48 in the display area 41 is set based on the frame image IS of one frame to be displayed in the display area 41. In one frame period F for displaying the frame image IS, the preset period PSP for writing the preset gradation value PSGV to all the pixels 48 in the display area 41 is provided before the write period SCP for writing the gradation value of the pixel signal SIGR<m,n>for each of the pixels 48 of the frame image IS.

More specifically, in the configuration according to the embodiment described above, the average value SIGRave of the gradation values of the pixel signals SIGR<m,n> for the respective pixels 48 of the frame image IS is set as the preset gradation value PSGV(R). In the first sub-field period SFR of one frame period F for displaying the frame image IS, the preset period PSPR for writing the preset gradation value PSGV(R) to all the pixels 48 in the display area 41 is provided just before the write period SCPR for writing the gradation value of the pixel signal SIGR<m,n> for each of the pixels 48 of the frame image IS.

In the configuration according to the embodiment described above, the average value SIGGave of the gradation values of the pixel signals SIGG<m,n> for the respective pixels 48 of the frame image IS is set as the preset gradation value PSGV(G). In the second sub-field period SFG of one frame period F for displaying the frame image IS, the preset period PSPG for writing the preset gradation value PSGV(G) to all the pixels 48 in the display area 41 is provided just before the write period SCPG for writing the gradation value of the pixel signal SIGG<m,n> for each of the pixels 48 of the frame image IS.

In the configuration according to the embodiment described above, the average value SIGBave of the gradation values of the pixel signals SIGB<m,n> for the respective pixels 48 of the frame image IS is set as the preset gradation value PSGV(B). In the third sub-field period SFB of one frame period F for displaying the frame image IS, the preset period PSPG for writing the preset gradation value PSGV(B) to all the pixels 48 in the display area 41 is provided just before the write period SCPB for writing the gradation value of the pixel signal SIGB<m,n> for each of the pixels 48 of the frame image IS.

In the first sub-field period SFR, the first light emitter 63R is turned on in the light emission period LMPR after the response period RESPR has elapsed after the write period SCPR. In the second sub-field period SFG, the second light emitter 63G is turned on in the light emission period LMPG after the response period RESPG has elapsed after the write period SCPG. In the third sub-field period SFB, the third light emitter 63B is turned on in the light emission period LMPB after the response period RESPB has elapsed after the write period SCPB. This configuration can suppress deterioration of display quality caused by collective presetting of the pixel gradation values.

### Modifications

While the embodiment above has described an active matrix color liquid crystal display panel driven by the FSC method as an example of the display panel 40, the configuration to which the present disclosure is applicable is not limited thereto. The following describes the configuration according to a modification of the embodiment to which the present disclosure is applicable.

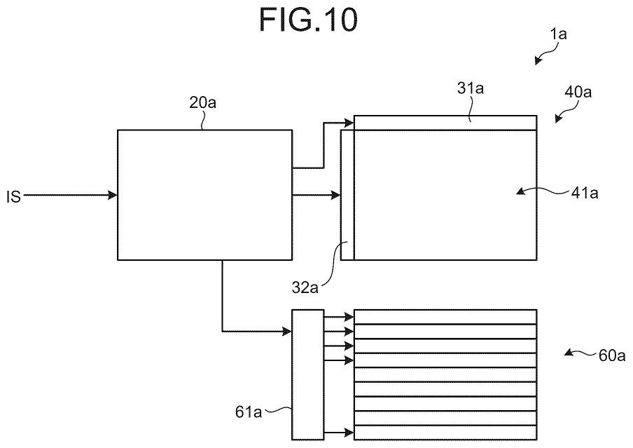

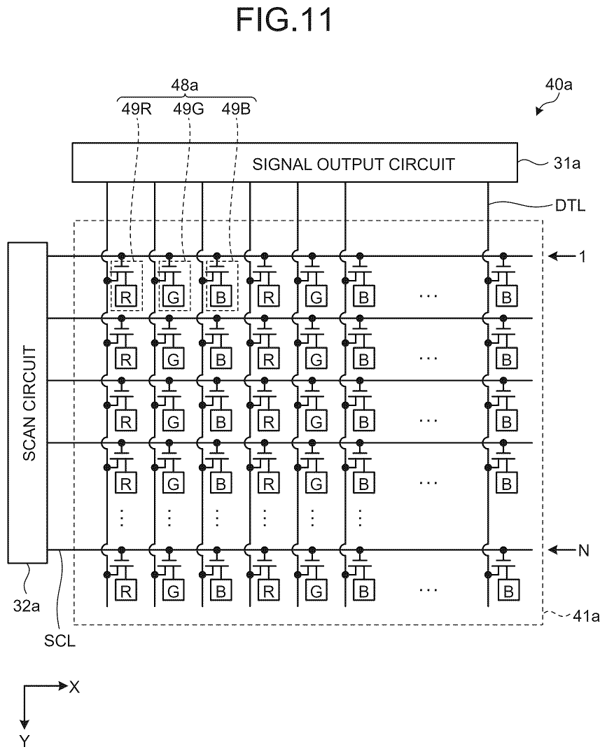

FIG. 10 is a schematic diagram of an example of a block configuration of the display device according to a modification of the embodiment. FIG. 11 is a schematic diagram of a configuration example of the display panel according to the modification of the embodiment. A display device 1a according to the modification of the embodiment includes a signal processing circuit 20a, a display panel 40a, and a light source 60a as a main block configuration. The display panel 40a includes a signal output circuit 31a and a scan circuit 32a.

As illustrated in FIG. 10, the display panel 40a is provided with a display area 41a in which a plurality of pixels 48a are arranged in the X-direction (first direction) and the Y-direction (second direction).

As illustrated in FIG. 11, each of the pixels 48a includes, for example, a first sub-pixel 49R that displays a first color (for example, red (R)), a second sub-pixel 49G that displays a second color (for example, green (G)), and a third sub-pixel 49B that displays a third color (for example, blue (B)). The example illustrated in FIG. 11 illustrates a configuration including a pixel configuration having a stripe array in which the first, the second, and the third sub-pixels 49R, 49G, and 49B are arranged in the X-direction.

The display panel 40a is, for example, a transmissive color liquid crystal display panel. A first color filter that overlaps a position provided with the pixel electrode of the first sub-pixel 49R and through which the first color passes is disposed on the display panel 40a. A second color filter that overlaps a position provided with the pixel electrode of the second sub-pixel 49G and through which the second color passes is also disposed on the display panel 40a. A third color filter that overlaps a position provided with the pixel electrode of the third sub-pixel 49B and through which the third color passes is also disposed on the display panel 40a.

The orientation of liquid crystal molecules contained in the liquid crystal layer of the display panel 40a is determined corresponding to the potential of the pixel electrode. Thus, the light transmittance of the first, the second, and the third sub-pixels 49R, 49G, and 49B, respectively is controlled.

The light source 60a is disposed on the back side of the display panel 40a. The light source 60a emits light toward the display panel 40a.

As illustrated in FIG. 10, the light source 60a includes a plurality of light emitters. The light emitters may be arranged in a plane on the light source 60a, or the light emitters may be arranged at an end of a light guide plate to emit light to a display surface of the display panel 40a (side light source). While the light emitters are LEDs, they are not limited thereto and may be CCFLS, for example. The light emitters are coupled to a light source control circuit 61a. The light source control circuit 61a controls the light emission timing, the light emission duration, and the light emission intensity under the operational control of the signal processing circuit 20a.

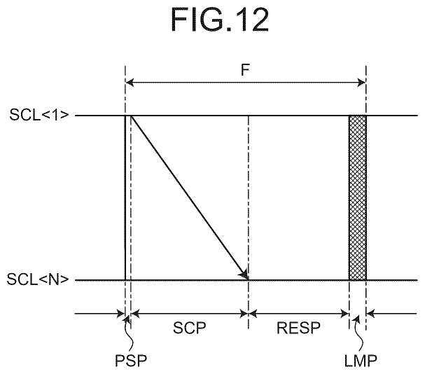

FIG. 12 is a diagram of an example of one frame period according to the modification of the embodiment. Also in the configuration according to the modification of the embodiment, as in the embodiment, the average value SIGave of the gradation values of the pixel signals SIG<m,n> for the respective pixels 48a of the frame image IS is set as the preset gradation value PSGV. In one frame period F for displaying the frame image IS, the preset period PSP for writing the preset gradation value PSGV to all the pixels 48a in the display area 41a is provided just before the write period SCP for writing the gradation value of the pixel signal SIG<m,n> for each of the pixels 48a of the frame image IS.

After the write period SCP, the light emitters of the light source 60a are turned on in the light emission period LMP after the response period RESP has elapsed. As in the embodiment, this configuration can suppress deterioration of display quality caused by collective presetting of the pixel gradation values.

While the present disclosure has described what is called a raster image in which the gradation values of the pixel signals of all the pixels in the display area are the same as an example of the frame image IS, the frame image IS is not limited to the raster image. In the present disclosure, the average value SIGave of the gradation values of the pixel signals SIG<m,n> for the respective pixels of the frame image IS is set as the preset gradation value PSGV in an actual displayed image in which the gradation values of the pixel signals SIG<m,n> for the respective pixels in the display area are assumed to be different. As a result, the difference can be statistically reduced between the gradation value of the pixel signal SIG<m,n> for each of the pixels 48a of the frame image IS written in the write period SCP and the preset gradation value PSGV written in the preset period PSP. Therefore, this configuration can suppress deterioration of display quality caused by collective presetting of the pixel gradation values in any kind of frame image IS.

While the present disclosure has described an example where the average value of the gradation values of each color for the respective pixels 48 of the frame image IS is set as the preset gradation value PSGV, the preset gradation value PSGV is not limited to the average value of the gradation values of each color for the respective pixels 48 of the frame image IS as described above.

Specifically, the preset gradation value PSGV set when the frame image IS is an all-black image with a luminance of 0% may be, for example, the minimum gradation value (=“0”) of the display panel 40 set as the target gradation value TGV. Alternatively, the preset gradation value PSGV set when the frame image IS is an all-black image with a luminance of 0% may be, for example, an approximation of the minimum gradation value (=“0”) of the display panel 40 set as the target gradation value TGV.

The preset gradation value PSGV set when the frame image IS is an all-white image with a luminance of 100% may be, for example, the maximum gradation value (=“255”) of the display panel 40 set as the target gradation value TGV. Alternatively, the preset gradation value PSGV set when the frame image IS is an all-white image with a luminance of 100% may be, for example, an approximation of the maximum gradation value (=“255”) of the display panel 40 set as the target gradation value TGV.

Although the preferred embodiments of the present disclosure have been described above, the present disclosure is not limited to the embodiments described above. The content disclosed in the embodiments is merely an example, and can be variously modified within the scope not departing from the gist of the present disclosure. For example, any modifications appropriately made within the scope not departing from the gist of the present disclosure also naturally belong to the technical scope of the present invention.

What is claimed is:

1. A display device comprising:
a display panel having a display area in which a plurality of pixels are arrayed in a first direction and a second direction orthogonal to the first direction;
a light source configured to output light to the display panel; and
a signal processing circuit configured to control the display panel and the light source, wherein
the signal processing circuit sets a preset gradation value written to all pixels in the display area based on a frame image of one frame to be displayed in the display area, and
the display panel has a preset period for writing the preset gradation value to all pixels in the display area before a write period for writing a gradation value for each pixel of the frame image in one frame period for displaying the frame image.

2. The display device according to claim 1, wherein the display panel has a light emission period for lighting up the light source when a predetermined response period has elapsed after the gradation value for each pixel of the frame image is written.

3. The display device according to claim 1, wherein the signal processing circuit sets an average value of the gradation values for the respective pixels of the frame image as the preset gradation value.

4. The display device according to claim 1, wherein the signal processing circuit sets the preset gradation value to a minimum gradation value of the display panel when the gradation values of all pixels of the frame image are the minimum gradation value.

5. The display device according to claim 1, wherein the signal processing circuit sets the preset gradation value to a maximum gradation value of the display panel when the gradation values of all pixels of the frame image are the maximum gradation value.

6. The display device according to claim 1, wherein one frame period for displaying the frame image includes a plurality of sub-field periods for displaying different colors.

7. The display device according to claim 6, wherein
the sub-field periods include:
a first sub-field period for displaying a first color;
a second sub-field period for displaying a second color; and
a third sub-field period for displaying a third color.

8. The display device according to claim 7, wherein
the light source comprises:
a first light emitter configured to emit light of the first color;
a second light emitter configured to emit light of the second color; and
a third light emitter configured to emit light of the third color.

9. The display device according to claim 8, wherein the display panel has a light emission period for lighting up the first light emitter when a predetermined response period has elapsed after the gradation value of the first color for each pixel of the frame image is written in the first sub-field period.

10. The display device according to claim 9, wherein the signal processing circuit sets an average value of the gradation values for the respective pixels of the first color of the frame image as the preset gradation value in the first sub-field period.

11. The display device according to claim 9, wherein the signal processing circuit sets the preset gradation value in the first sub-field period to a minimum gradation value of the display panel when the gradation values of the first color of all pixels of the frame image are the minimum gradation value.

12. The display device according to claim 9, wherein the signal processing circuit sets the preset gradation value in the first sub-field period to a maximum gradation value of the display panel when the gradation values of the first color of all pixels of the frame image are the maximum gradation value.

13. The display device according to any one of claim 10, wherein the display panel has a preset period for writing the preset gradation value in the first sub-field period to all pixels in the display area before a write period for writing the gradation value of the first color for each pixel of the frame image in the first sub-field period.

14. The display device according to claim 8, wherein the display panel has a light emission period for lighting up the second light emitter when a predetermined response period has elapsed after the gradation value of the second color for each pixel of the frame image is written in the second sub-field period.

15. The display device according to claim 14, wherein the signal processing circuit sets an average value of the gradation values for the respective pixels of the second color of the frame image as the preset gradation value in the second sub-field period.

16. The display device according to claim 14, wherein the signal processing circuit sets the preset gradation value in the second sub-field period to a minimum gradation value of the display panel when the gradation values of the second color of all pixels of the frame image are the minimum gradation value.

17. The display device according to claim 14, wherein the signal processing circuit sets the preset gradation value in the second sub-field period to a maximum gradation value of the display panel when the gradation values of the second color of all pixels of the frame image are the maximum gradation value.

18. The display device according to any one of claim 15, wherein the display panel has a preset period for writing the preset gradation value to all pixels in the display area before a write period for writing the gradation value of the second color for each pixel of the frame image in the second sub-field period.

19. The display device according to claim 8, wherein the display panel has a light emission period for lighting up the third light emitter when a predetermined response period has elapsed after the gradation value of the third color for each pixel of the frame image is written in the third sub-field period.

20. The display device according to claim 19, wherein the signal processing circuit sets an average value of the gradation values for the respective pixels of the third color of the frame image as the preset gradation value in the third sub-field period.
